(19) United States
(12) Patent Application Publication
(10) Pub. No.: US 2009/0178717 A1
(43) Pub. Date: Jul. 16, 2009

(54) MIXING AND PUMPING SYSTEM FOR USE WITH INSTALLED HYDRONIC RADIANT FLOOR HEATING SYSTEMS AND THE LIKE

(76) Inventor: Michael Mirchildon, Barrie (CA)

Correspondence Address: CALFEE HALTER & GRISWOLD, LLP, 800 SUPERIOR AVENUE, SUITE 1400, CLEVELAND, OH, 44114, US

(21) Appl. No.: 12/354,260

(22) Filed: Jan. 15, 2009

Related U.S. Application Data
(60) Provisional application No. 61/021,124, filed on Jan. 15, 2008.

(51) Int. Cl. F16K 17/38; F24D 5/10

(52) U.S. Cl. 137/80; 237/69

(57) ABSTRACT

A mixing and pumping module for use with an installed hydronic radiant floor heating system is described. The module comprises a primary loop for circulating water to and from a boiler; a secondary loop in valve fluid communication with said primary loop and with the manifold of a hydronic radiant floor heating system, for circulating water into and out of the manifold; and means for regulating the flows of water through the primary loop, secondary loop and manifold loop, for selective delivery of heating capacities over a wide range of heating requirements, in a configuration which is compact and readily mounted to a frame for installation on a wall of the residence or commercial building in which the system is installed.

### RELATED APPLICATION

This application claims priority to, and any other benefit of, U.S. Provisional Patent Application No. 61/021,124 filed Jan. 15, 2008, which is herein incorporated by reference.

### BACKGROUND OF THE INVENTION

1. Field of the Invention

This invention relates to a hydronic radiant floor system for pumping heated water from a boiler or other heat source through one or more manifolds (tubing laid in a pattern underneath a floor, in the case of the floor heating system). The system of the invention is characterized by simpler access and maintenance and more efficient heat delivery when compared with radiant floor heating systems currently installed in residential and commercial buildings.

2. Description of the Related Art

In general terms, a radiant heating system supplies heat directly to the floor or wall or ceiling panels in a house. “Hydronic” radiant floor heat refers to those systems in which hot water is circulated through tubing laid out in a pattern (a “manifold”) underneath the floor, behind the baseboards and/or within the ceiling of a room to be heated. Different structures for hydronic radiant floors are illustrated in U.S. Pat. Nos. 4,212,348 (Kobayashi); 4,782,889 (Bourne); and 6,270,016 (Fiedrich). All of the aforementioned patents are incorporated herein by reference for their teaching on hydronic radiant floorboards incorporating one or more manifolds for connection to a source of hot water.

The temperature in a manifold is controlled by regulating the flow of hot water therethrough. This is accomplished by a system of valves, pumps, thermostats and controls, which may be delivered to a job site for assembly and installation in the hydronic radiant floor heating system. Alternatively, the regulating pumping system may be a pre-wired and pre-plumbed modular apparatus. An example of the latter is described in U.S. Pat. No. 5,390,660 (Danielson) which discloses a module comprising various pump, valve and control means together with an integral water heater, all on a moveable support frame.

Systems which have been used to date for supplying fluid to an installed hydronic radiant floor heating system and the like are not readily adaptable to different heating loads and are energy-inefficient when used for simultaneously controlling heating of a number of rooms, a task hereinafter referred to as “multiple zoning”. Further, none of the existing systems lends itself readily to connection to different kinds of fluid heaters (electric, gas, solar).

It was my objective to design a hydronic radiant system with multiple zoning capability, and high energy efficiency with adjustable delivery capacities over a wide range of heating requirements in a pre-plumbed pre-wired apparatus that would take up relatively little space when mounted to a wall surface and would be simple to maintain.

### SUMMARY OF THE INVENTION

The invention in its broadest expression is an improved module for connection to an installed hydronic radiant floor heating system having a fluid supply line and a fluid return line, the improvement comprising the combination of:

a primary loop for circulating water to and from a boiler;

a secondary loop in valved fluid communication with said primary loop and with the manifold of the hydronic radiant floor heating system for circulating water into and out of the manifold; and

means for regulating the flows of water through said primary loop, said secondary loop and said manifold loop, for selective delivery of heating capacities over a wide range of heating requirements.

### BRIEF DESCRIPTION OF THE DRAWING

FIG. 1 is a schematic front perspective view of a hydronic radiant heating system according to a preferred embodiment of the invention.

### DESCRIPTION OF THE PREFERRED EMBODIMENT

Apparatus according to the invention comprises a primary (boiler) comprising parallel supply and return channels 10_{S} and 10_{R}, respectively which communicate and are connected to a larger diameter conduit 12, which also functions as an air elimination tank, air being expelled through air vent 12a.

Hot water from the boiler or other heat source is introduced into main supply channel 10_{S} through intake valve 11_{S} by means of a boiler pump (not shown). The intake flow rate is measured by flowmeter 13. Water is recycled directly to the boiler through return valve 11_{R} on return channel 10_{R}.

Manifold pumps 14a, 14b, 14c and 14d impel water into one or more manifolds through respective feeding channels 15a-15d from a secondary (manifold) loop. The secondary manifold loop is a generally horizontal U-shaped tube having a lower horizontal channel 16s feeding water into manifold pumps 14a-14b through respective isolation valves 17a-17d and then out into feeding channels 15a-15d in the direction of arrows A.

The primary (boiler) loop and the secondary (manifold) loop are preferably fabricated of welded stainless steel pressure tested at 100 p.s.i. The larger diameter conduit (air elimination tan) 12 of the boiler loop in the preferred embodiment is about 5″ type and the other boiler and manifold pipe sections are 2″. On the air elimination tank 12, valve member 12a functions as an automatic air release.

The second horizontal portion 16_{R} of the manifold loop is in fluid communication with return lines 18a-18d by way of respective return ball valves 19a-19d and associated bleeder hose bibs 20a-20d. Fluid from a manifold can be returned to the manifold loop in the direction of arrows B, when the return valves 19a-19d are closed and hose bibs 20a-20d are open. Return line 18a returns fluid to the same manifold as is fed by manifold supply pipe 15a, and correspondingly for supply pipe/return line pairs 15b/18b etc. The principal flow directions through the boiler loop when in use are indicated by arrows C and D respectively.

The manifold loop is fed hot water from the boiler loop through fluid feed hose 20a by means of an injection pump 21. Water flowing through the manifold loop may be shunted back into the boiler loop through hose bib 20a, to a degree controlled by globe valve 23.

Injection pump 21 is a variable speed pump and its operation is regulated by electronic variable speed injection control means indicated generally at 24, affixed to a mounting plate 25a. Selective activation of manifold pumps 14a-14d is controlled by means of an electronic manifold pump switching module 26, also mounted to plate 25a.

The two control means 24 and 26 are responsive to signals from sensors installed in the system. In response to a drop in temperature in the region serviced by one of the manifolds, measured conventionally by thermostats, a relay from the pump switching module is activated to turn the associated manifold pump on and pump hot water from the manifold loop to the manifold to meet the heat demand.

A tridicator 28 measures temperature and pressure in supply line 10_{S} of the boiler loop, while a mixing sensor 30 monitors the temperature of water being fed to the manifolds. An outdoor thermostat (not shown) monitors the temperature outside the building or other installation served by a manifold. In response to these sensors, the variable speed injection module 24 activates injection pump 21 to regulate the temperature of the fluid in the manifold loop.

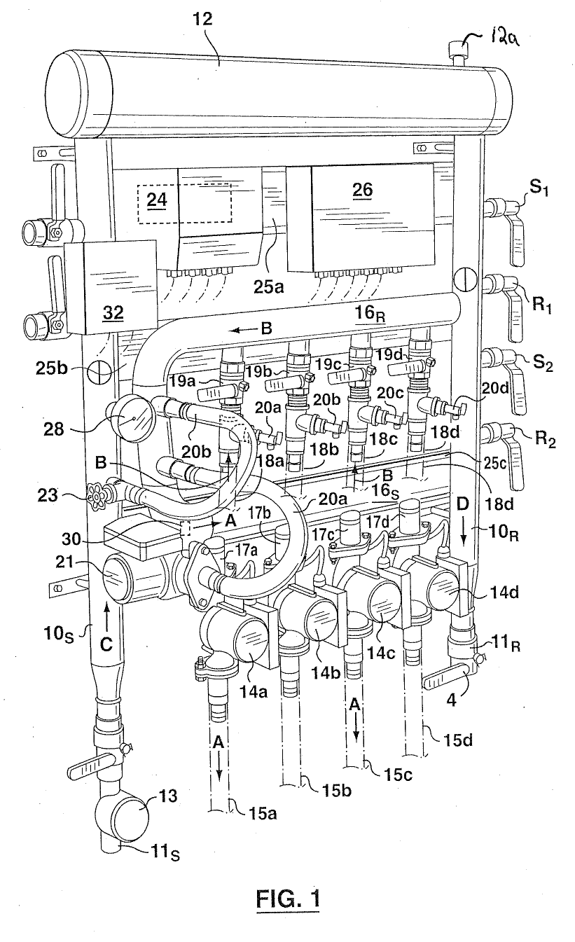

I have determined that, through use of electronic controller 24 to control the speed of injection pump 23, and hence the temperature of water delivered to radiant floor manifolds, very stable floor temperatures can be obtained, with none of the “overshoots” to which current systems are subject. A low-water cutoff 32 turns the boiler off if there is a low water level in the system, as a safety precaution. The system can use three different pump sizes for tailoring the flow requirements to various applications.

Where the above-noted dimensions of pipe are used to make the primary and secondary loops, from 5,000 up to 16,000 square feet of floor space provided with manifolds can be efficiently heated and temperature controlled with a system according to the present invention. The entire module depicted in FIG. 1 can be mounted on a framework having a rectangular dimension of about 42″×42″. By means of mounting plates 25b and 25c, the U-frame of the manifold loop is angled rearwardly so that return channel 16_{R} is horizontally displaced relative to supply channel 16s. This offset allows all of the leaders 18a-18d from the manifolds to be compactly positioned behind the manifold pumps and occupy a space behind the total system.

Optionally, the system as shown may be provided with three additional high temperature supply and return ports S₁ and R₁, S₂ and R₂, etc. which can be used for other applications requiring controlled heating, e.g. indoor pool, etc.

The improved mixing and pumping module according to the invention has been described with reference to a preferred embodiment for hydronic radiant floor heating systems for residential or commercial buildings. It will be understood that the system can be used in connection with water heated by any source of energy (electric, gas, solar) and that peripheral components of the module can be modified accordingly. The description is not intended to limit the invention to the specific embodiment described but is intended to cover all alternatives, modifications and equivalents as may be made by those skilled in the art within the spirit and scope of the invention as defined by the appended claims.

1. A mixing and pumping module for connection to an installed hydronic radiant floor heating system having a fluid supply line and a fluid return line and a manifold extending beneath a floor surface to be heated, said module comprising in combination:
a primary loop for circulating water to and from a boiler;
a secondary loop in valved fluid communication with said primary loop and with the manifold of the floor heating system for circulating water into and out of the manifold; and
means for regulating the flows of water through said primary loop, said secondary loop and said manifold loop for selective delivery of heating capacities over a wide range of heating requirements.

2. A module according to claim 1, wherein said primary loop is of a generally inverted vertical U-shape, comprising a vertically oriented water intake channel, a vertically oriented water return channel and a larger diameter horizontal channel extending therebetween at the upper ends thereof, said horizontal channel including an in-line air separation valve.

3. A module according to claim 2, wherein said secondary loop is a horizontally oriented generally U-shaped tube having a lower horizontal channel for supplying water to said manifold and an upper horizontal channel for receiving water from said manifold.

4. A module according to claim 3, wherein said means for regulating the flows of water comprises:
(i) a variable-speed injection pump for delivering hot water from said water intake channel of the primary loop through a feed hose into said secondary loop;
(ii) from one to four manifold pumps for delivering hot water to said manifold, each said manifold pump being operably connected to said lower horizontal channel of the secondary loop by an isolation valve;
(iii) from one to four water return lines connected to the manifold, each said return line being connected at an end remote from the manifold to the upper horizontal channel of said secondary loop by return valve means; and
(iv) sensors and electronic control means for controlling the speed of the injection pumps and for selective switching of said from one to four manifold pumps.

5. A module according to claim 4, wherein said sensors comprise a tridicator to monitor the temperature and pressure of water in the water intake channel of said primary loop, a mixing sensor to monitor the temperature of water supplied to the manifold, and an external thermostat for monitoring the outdoor temperature.
